(19) United States
(12) Patent Application Publication
(10) Pub. No.: US 2018/0265208 A1
(43) Pub. Date: Sep. 20, 2018

(54) AIR INTAKE STRUCTURE AND AIRFLOW CONTROL SYSTEM

(71) Applicant: Hani M. Saeed Yousef, Ajman (AE)

(72) Inventor: Hani M. Saeed Yousef, Ajman (AE)

(21) Appl. No.: 15/540,262

(22) PCT Filed: Oct. 24, 2015
(86) PCT No.: PCT/IB2015/058209

§ 371 Date: Jun. 28, 2017

(51) Int. Cl. B64D 33/02; B64C 21/08; B64C 21/06; B64D 15/04; B64D 27/18; B64C 21/04

(52) U.S. Cl. CPC B64D 33/02; B64C 21/08; B64C 21/06; B64D 2033/0226; B64D 27/18; B64C 21/04; B64D 15/04

(57) ABSTRACT

An aircraft design using an air intake structure for reducing drag and assisting aerodynamic control surfaces in controlling the aircraft. The air intake structure comprises an outer skin including a plurality of perforations, a plurality of closing plates for covering corresponding perforations and an actuator operatively connected to the plurality of closing plates. The outer skin creates a chamber between the outer skin and a fuselage of the aircraft and extends to cover engines of the aircraft and adapted to restrict airflow into the engines. The plurality of closing is movable between a closed position covering the corresponding perforations and, an open position, uncovering the corresponding perforations. The actuator is used for positioning the plurality of closing plates between the closed position and the open position. The aircraft design also includes a wing for minimizing an airfoil boundary layer separation and de-icing a leading edge of the wing.

### FIELD OF THE INVENTION

The present invention relates to aircraft design. More particularly, the present invention relates to an air intake structure absorbing and directing airflow into engines of an aircraft for reducing drag on the aircraft.

### BACKGROUND OF THE INVENTION

Drag is an aerodynamic force that opposes an aircraft's motion through the air and can be generated by every part of the aircraft.

Drag is generally generated by the interaction and contact of a solid body, such as an aircraft, with a fluid, such as air. In aircraft design, drag is generally a function of aircraft configuration, altitude and speed. Drag is also known to increase exponentially with speed, therefore if the aircraft speed is doubled, the drag force will be quadrupled.

Among the drag forces acting on the aircraft, two forms of drag relate to the aircraft configuration and are known as parasite drag and interference drag. Parasite drag can be generated by the shape of the aircraft, which results from the direct contact of the aircraft with the airflow. Interference drag can be generated from the interaction of deflected airflows from the body of the aircraft for example interference between deflected air from the fuselage onto the airflow generated by the wings.

Drag generally decreases the aerodynamic efficiency of the aircraft. The decrease in efficiency can cause higher fuel burn and therefore increase greenhouse gas emissions.

Hence, in light of the aforementioned, there is a need for an aircraft which, by virtue of its design and components, would be able to provide a more aerodynamically efficient design by reducing drag forces.

### SUMMARY OF THE INVENTION

One object of the present invention is to provide a solution to at least one of the above-mentioned prior art drawbacks.

The present invention relates to an air intake structure exposable to an airflow, for use on an aircraft having a fuselage, wings and engines. At least one of the engines having an air intake area and being mounted on top of the wings proximate the fuselage, for reducing drag and assisting aerodynamic control surfaces in controlling the aircraft.

In accordance with an aspect of the present invention, the air intake structure comprises:
an outer skin comprising a plurality of perforations, having an exterior surface exposable to the airflow and an opposite interior surface, mountable on the aircraft relative to the fuselage for creating a chamber between the outer skin and the fuselage, said outer skin defining a forward portion, a middle portion extending longitudinally along a roll axis to cover said at least one engine and adapted to restrict airflow into said at least one engine, and an aft portion;
a plurality of closing plates operatively mounted on the interior surface of the outer skin for covering corresponding perforations on the outer skin and movable between a closed position covering the corresponding perforations and, an open position, uncovering the corresponding perforations; and
an actuator operatively connected to the plurality of closing plates for positioning said plurality of closing plates between the closed position and the open position.

In some implementations, the plurality of perforations includes a plurality of forward perforations formed on the forward portion, a plurality of middle perforations formed on the middle portion and a plurality of aft perforations formed on the aft portion.

In some implementations, the forward portion covers a nose cone of the aircraft.

In some implementations, the aft portion covers a vertical stabilizer defining a port surface and an opposite starboard surface and a horizontal stabilizer defining a top surface and an opposite bottom surface.

In some implementations, the middle portion covers a section of the fuselage extending between the forward portion and the aft portion.

In some implementations, an offset distance between the outer skin and the fuselage is configured to allow sufficient air intake into the engines.

In some implementations, the plurality of forward perforations gradually decreases in size along the roll axis from a tip of the nose cone to an end of the nose cone.

In some implementations, the plurality of forward perforations defines an area that is configured to account for 50 to 75 percent of the air intake area of the engines above the wings.

In some implementations, edges of the plurality of forward perforations and the plurality of aft perforations are operatively connected to a heating element for heating said plurality of forward perforations and plurality of aft perforations.

In some implementations, the plurality of aft perforations includes vertical stabilizer perforations formed on the port surface and the starboard surface of the vertical stabilizer and horizontal stabilizer perforations formed on the top surface and bottom surface of the horizontal stabilizer.

In some implementations, the plurality of aft perforations defines an area that is configured to account for 20 to 40 percent of the air intake area of the engines.

In some implementations, a leading edge of the vertical stabilizer and a leading edge of the horizontal stabilizer include micro perforations.

In some implementations, at least one edge of a windshield section of the aircraft is in fluid communication with the fuselage chamber.

In some implementations, covering the plurality of closing plates on a surface of the vertical stabilizer causes a corresponding uncovering of the plurality of closing plates on the opposite surface of the vertical stabilizer.

In some implementations, covering the plurality of closing plates on a surface of the horizontal stabilizer causes a corresponding uncovering of the plurality of closing plates on the opposite surface of the horizontal stabilizer.

In some implementations, the air intake structure further includes struts connected to the interior surface of the outer skin and to the fuselage for mounting said outer skin onto the aircraft.

In some implementations, the air intake structure further comprises a chamber segmentation wall mounted inside the chamber and dividing said chamber into a left forward chamber, a left middle chamber, a left aft chamber, a right forward chamber, a right middle chamber and a right aft chamber.

In some implementations, the air intake structure further comprises a closable gate mounted inside the chamber for fluidly isolating airflow from a divided chamber selected from the group of the left forward chamber, the left middle chamber, the left aft chamber, the right forward chamber, the right middle chamber and the right aft chamber.

In accordance with another aspect of the present invention, there is provided an aircraft wing for minimizing an airfoil boundary layer separation and de-icing a leading edge of the wing, the wing comprising:
a slot along a wingspan of the wing; and
an air duct mounted inside the leading edge of the wing and being in fluid communication with air exhaust of an engine, said air duct being configured to deflect a portion of the air exhaust from the engine towards the leading edge and to cause the portion of the air exhaust to exit through the slot.

In some implementations, the air duct is in fluid communication with a corresponding air duct of a second wing.

In some implementations, the aircraft wing further comprises an isolating system for fluidly isolating the air duct from the air exhaust of the engine.

The components, advantages and other features of the invention will become more apparent upon reading of the following non-restrictive description of some optional configurations, given for the purpose of exemplification only, with reference to the accompanying drawings.

### BRIEF DESCRIPTION OF THE DRAWINGS:

FIG. 1 is a side perspective view of an aircraft according to an embodiment of the present invention.

FIG. 2 is a top perspective view of part of the aircraft shown in FIG. 1.

FIG. 3 is a front perspective view of part of the aircraft shown in FIG. 1.

FIG. 4 is another front perspective view of part of the aircraft shown in FIG. 1.

FIG. 5 is a side perspective view of part of the aircraft showing a vertical and a horizontal stabilizer.

FIG. 5A is a perspective view of a perforation mounted on the aircraft half covered by a closing plate.

FIG. 5B is a perspective view of the perforation fully covered by the closing plate shown in FIG. 5A.

FIG. 6A is a top perspective view of part of an aircraft subjected to airflow according to an embodiment of the present invention.

FIG. 6B is a top perspective view of part of an aircraft subjected to airflow according to prior art.

FIG. 7 is a cross-sectional view of a fuselage of the aircraft shown in FIG. 1.

FIG. 8 is a cross-sectional view of a wing of the aircraft according to an embodiment of the present invention.

FIG. 9 is a top perspective view of part of the aircraft showing a forward left chamber, a left middle chamber and a left aft chamber.

### DETAILED DESCRIPTION OF PREFERRED EMBODIMENTS OF THE INVENTION

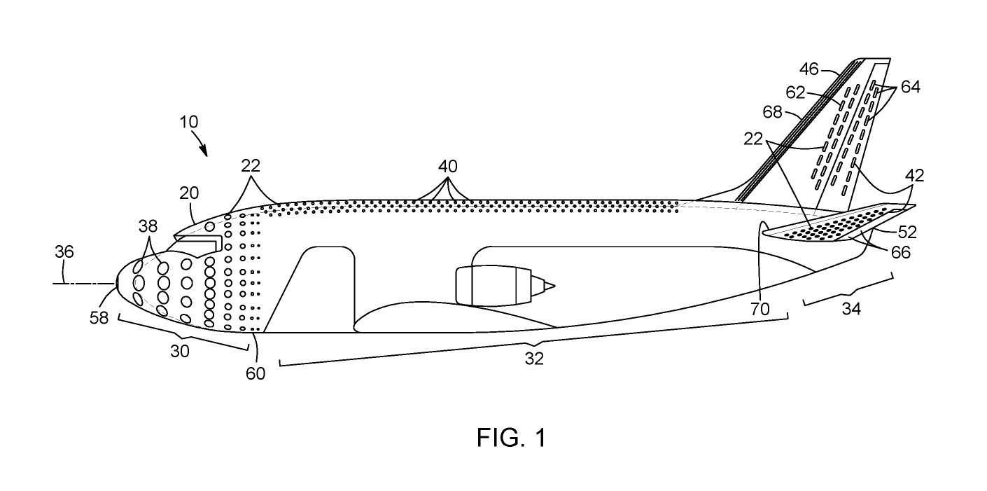

Referring to FIG. 1, there is shown an aircraft having a fuselage, wings and engines. Each engine has an air intake area corresponding approximately to a frontal area of the engine. Preferably, the engines are mounted on top of the wings and in close proximity with the fuselage of the aircraft, as shown in FIG. 1.

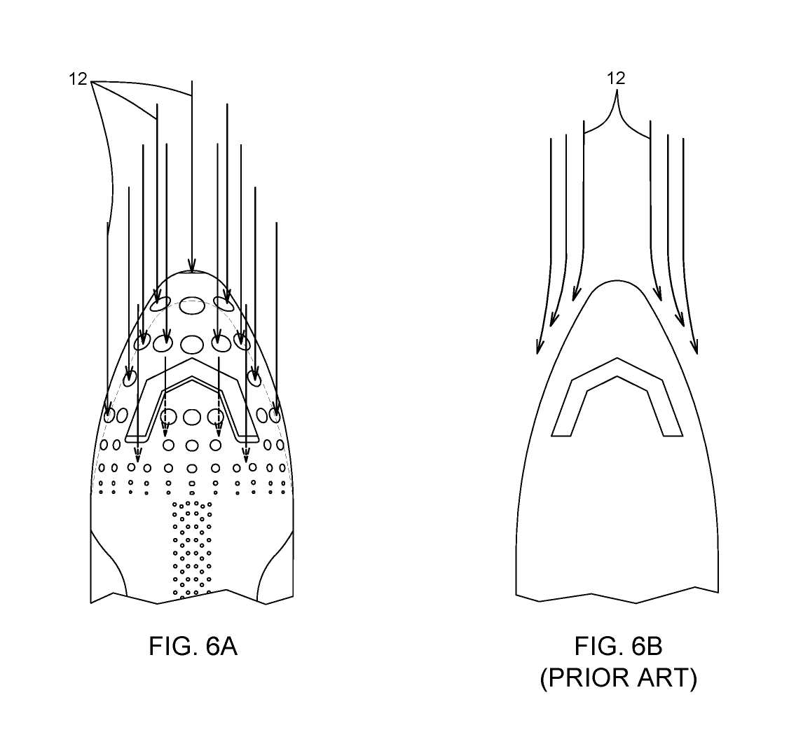

Still referring to FIG. 1 and to FIGS. 6A and 6B, there is shown an aircraft with an air intake structure 10, exposed to an airflow 12, for reducing drag and assisting aerodynamic control surfaces in controlling the aircraft. The air intake structure 10 refers to a structure designed to receive ambient air or airflow 12 and to direct such air towards the aircraft engines as air intake. The air intake structure 10 is also designed to supply the engines with the required intake air. A difference between the present invention and the prior art is shown in FIGS. 6A and 6B. According to the prior art, the outer fuselage of the aircraft moving with a given velocity contacts the airflow 12. This contact yields resistance to the motion of the aircraft and generates drag. However, according to the present invention, the air intake structure 10 absorbs a substantial amount of the airflow 12 into the engines through the front perforations and therefore reduces the drag caused by the contact of the fuselage of the aircraft with the airflow 12.

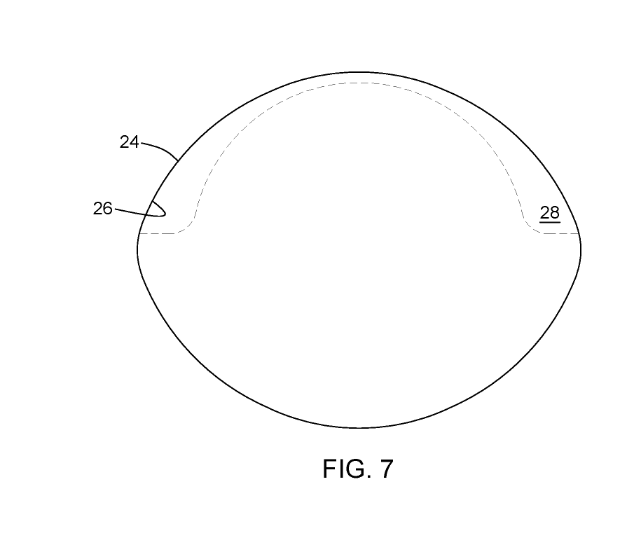

The air intake structure 10 comprises an outer skin 20. The outer skin 20 has an exterior surface 24 exposed to the airflow 12 and an opposite interior surface 26, mountable on the aircraft relative to the fuselage for creating a chamber 28 between the outer skin 20 and the fuselage. The outer skin 20 is a surface that can be mounted on the fuselage and can include a surface made from a sheet metal, plastic, glass, composites, etc. The outer skin 20 may be mounted on the fuselage using different mounting mechanisms. In a preferred embodiment, the air intake structure 10 further includes struts connected to the interior surface 26 of the outer skin 20 and to the fuselage for mounting the outer skin 20 onto the aircraft. As shown in FIG. 7, the chamber 28 is a void created between the outer skin 20 and the fuselage. In operation, airflow 12 is sucked into the chamber 28 which is then directed to the engine as air intake.

The outer skin 20 defines a forward portion 30, a middle portion 32 extending longitudinally along a roll axis 36 to cover the engines and adapted to restrict airflow into the engines, and an aft portion 34.

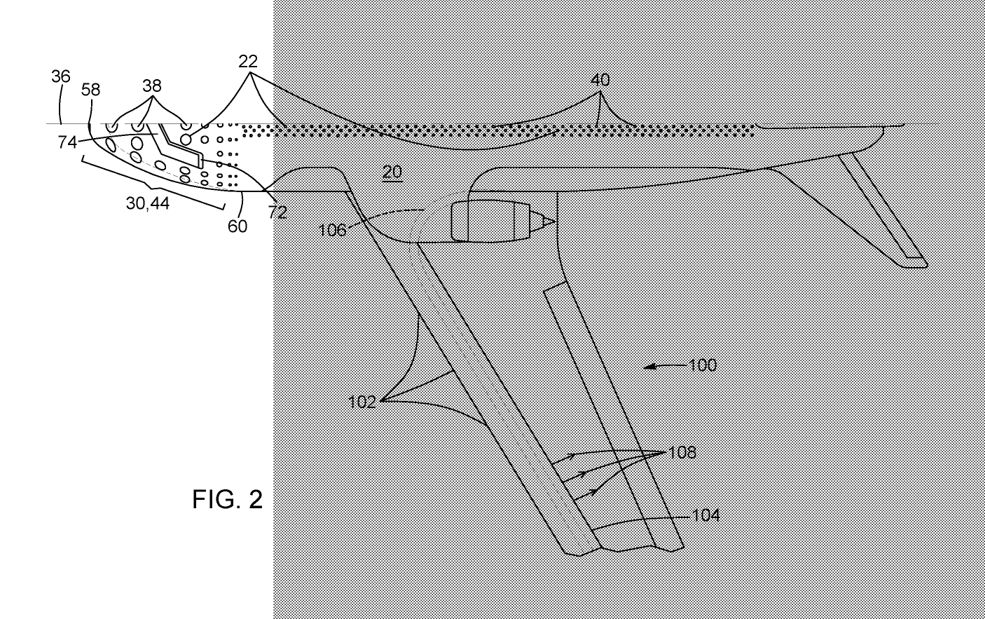

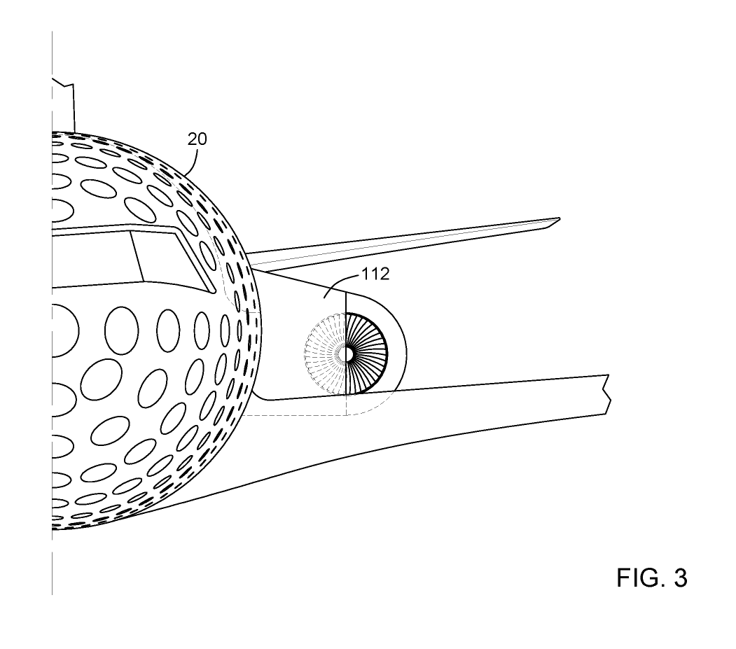

In a preferred embodiment and with reference to FIGS. 1 and 2, the forward portion 30 covers a nose cone 44 of the aircraft. The nose cone 44 refers to the forward section of the aircraft and usually ends when a cross sectional diameter of the nose cone 44 has reached a fuselage cabin diameter.

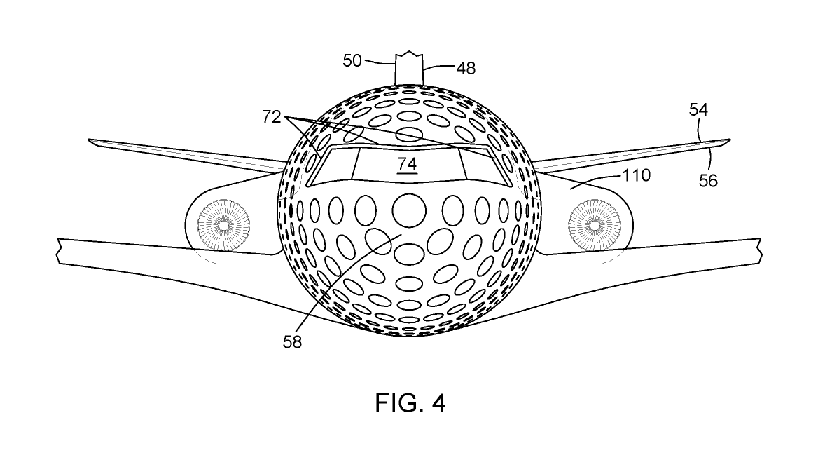

With reference to FIGS. 1 and 4, the aft portion 34 covers a vertical stabilizer 46 defining a port surface 48 and an opposite starboard surface 50 and a horizontal stabilizer 52 defining a top surface 54 and an opposite bottom surface 56.

The middle portion 32 covers a section of the fuselage extending between the forward portion 30 and the aft portion 34.

Preferably, the outer skin 20 is designed to fit a specific type of aircraft and to feed the engines with sufficient air. Therefore, every aircraft type can have a corresponding outer skin 20. An offset distance between the outer skin 20 and the fuselage is configured to allow sufficient air intake into the engines.

The outer skin 20 includes a plurality of perforations 22 for receiving the airflow 12, as shown in FIGS. 1 and 6A. The plurality of perforations 22 can comprise a perforated, slotted, or otherwise porous skin on the outer skin 20 and can have different sizes and shapes. The plurality of perforations 22 are configured to be in fluid communications with the engines through the chamber 28. In operation, the engines are almost continuously sucking air intake and creating a vacuum in the chamber 28. Consequently, creating suction through the plurality of perforations 22.

The plurality of perforations 22 includes a plurality of forward perforations 38 formed on the forward portion 30, a plurality of middle perforations 40 formed on the middle portion 32 and a plurality of aft perforations 42 formed on the aft portion 34.

In a preferred embodiment, the plurality of forward perforations 38 gradually decreases in size along the roll axis 36 from a tip 58 of the nose cone 44 to an end 60 of the nose cone 44. A perforation at the tip 58 of the nose cone 44 will be the largest in size since the tip 58 of the nose cone 44 usually creates large drag forces and hence the gradual decrease in size of the forward perforation 38. Instead of deflecting the airflow 12 away from the nose cone 44 and therefore increasing the drag forces, the airflow 12 is absorbed by the plurality of forward perforations 38. The plurality of forward perforations 38 can define an area that is configured to account for 50 to 75 percent of the air intake area of the engines.

The plurality of aft perforations 42 includes vertical stabilizer perforations 64 formed on the port surface 48 and the starboard surface 50 of the vertical stabilizer 46 and horizontal stabilizer perforations 66 formed on the top surface 54 and bottom surface 56 of the horizontal stabilizer 52. In addition to reducing boundary layer separation along the vertical stabilizer 46 and the horizontal stabilizer 52, the plurality of aft perforations 42 can be used to manoeuver the aircraft by creating pressure differences on the vertical stabilizer 46 and on the horizontal stabilizer 52. In fact, the aft perforations 42 can replace a rudder and/or elevators of an aircraft. The use of the aft perforations 42 as flight control surfaces is described in more details below. In some implementations, the plurality of aft perforations 42 defines an area that is configured to account for 20 to 40 percent of the air intake area of the engines.

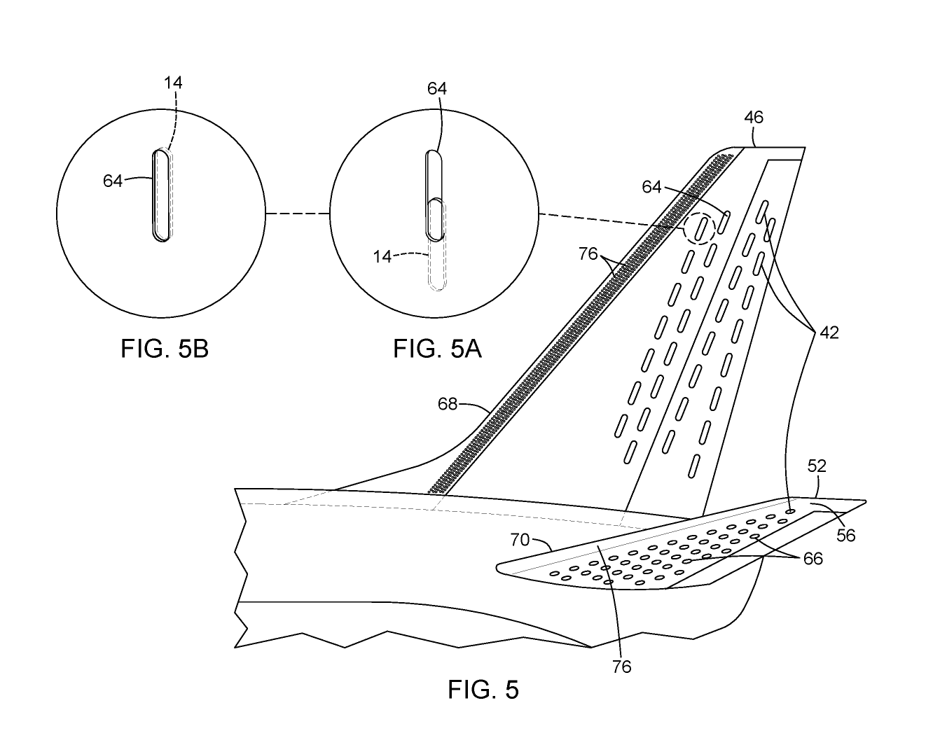

In some implementations, as shown in FIG. 5, a leading edge of the vertical stabilizer 68 and a leading edge of the horizontal stabilizer 70 include micro perforations 76. The micro perforations 76 are similar to the plurality of perforations 22 except that they are smaller in size.

In some implementations, to help preventing ice formation onto the plurality of perforations 22, edges 62 of the plurality of forward perforations 38 and the plurality of aft perforations 42 are operatively connected to a heating element (not shown) for heating said plurality of forward perforations 38 and plurality of aft perforations 42. The heating element can be a structure that produces and transfers the heat onto the edges 62 shown in FIG. 1.

Referring to FIG. 4, there is shown a windshield 74 of the aircraft. Aircraft windshields 74 are another source of parasitic drag generation on the aircraft. In some implementations, to reduce drag generated around the windshield 74, at least one edge of a windshield section 72 of the aircraft is in fluid communication with the fuselage chamber 28. Therefore the airflow 12 passes through the at least one edge of a windshield section 72 into the engines.

With reference to FIG. 5, the use of the aft perforations 42 as flight control surfaces will be described below.

The air intake structure 10 comprises a plurality of closing plates 14 operatively mounted on the interior surface 26 of the outer skin 20, for covering corresponding perforations, and movable between a closed position covering the corresponding perforations and, an open position, uncovering the corresponding perforations. The closing plates 14 are rigid structures sized and configured to slide relative to the corresponding perforations for covering and uncovering said perforations. Preferably, the plurality of closing plates 14 are mounted adjacent to the vertical stabilizer perforations 64 and to the horizontal stabilizer perforations 66.

The air intake structure 10 further comprises an actuator operatively connected to the plurality of closing plates 14 for positioning said plurality of closing plates 14 between the closed position and the open position. The actuator can comprise electric, pneumatic or hydraulic actuators.

In a neutral configuration, the plurality of closing plates 14 is positioned such that the vertical stabilizer perforations 64 and the horizontal stabilizer perforations 66 are about half covered, as shown in FIG. 5A. In the neutral configuration, with abstraction to exterior aerodynamic forces, pressure difference between the port surface 48 and starboard surface 50 of the vertical stabilizer 46 and between the top surface 54 and bottom surface 56 of the horizontal stabilizer 52 is substantially zero.

To create a pressure difference on the vertical stabilizer 46 and/or on the horizontal stabilizer 52, the actuator displaces a portion of the plurality of closing plates 14 for covering the corresponding perforations, as shown in FIG. 5B.

In a preferred embodiment, in order to maximize the pressure difference between two opposite surfaces of a stabilizer, the plurality of closing plates 14 on each surface of a stabilizer is configured to move in opposite direction from the corresponding plurality of closing plates 14 on the other surface of the stabilizer.

Therefore, covering the vertical stabilizer perforations 64 on a surface of the vertical stabilizer 46 causes a corresponding uncovering of the vertical stabilizer perforations 64 on the opposite surface of the vertical stabilizer 46, and covering the horizontal stabilizer perforations 66 on a surface of the horizontal stabilizer 52 causes a corresponding uncovering of the horizontal stabilizer perforations 66 on the opposite surface of the horizontal stabilizer 52. This approach can be used in conjugation with existing control surfaces, such as a rudder and elevators. In some implementations, the rudder and elevators can be locked in place while using the vertical stabilizer perforations 64 and he horizontal stabilizer perforations 66 to manoeuver the aircraft, as described above. In case of engine failure, the rudder and elevators can be unlocked to control the aircraft.

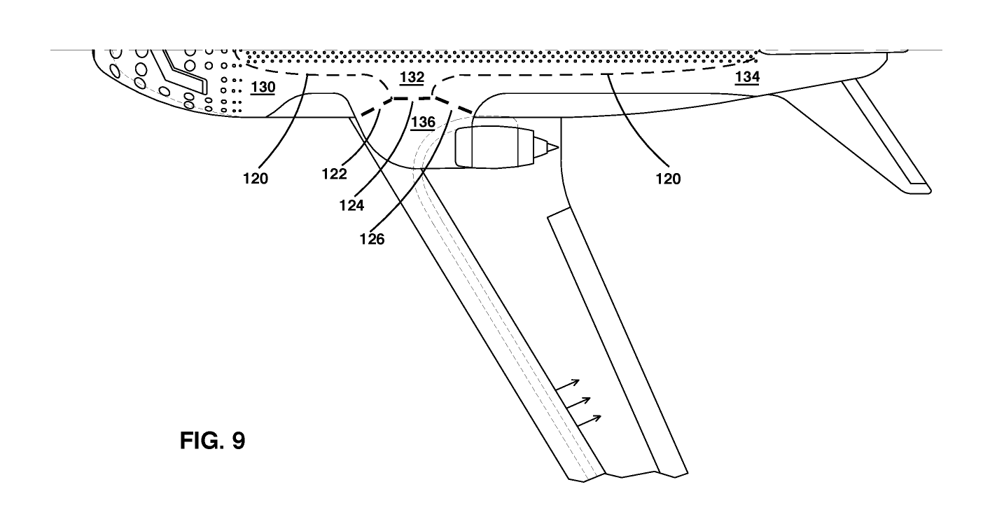

With reference to FIG. 9, the air intake structure 10 can further includes a chamber segmentation wall 120 and a closable gate on each side of the aircraft, i.e. port (left) and starboard (right). In the illustrated embodiment of FIG. 9, the chamber segmentation wall 120 is mounted inside the chamber 28 and divides the chamber 28 on the left side into a left forward chamber 130, a left middle chamber 132 and a left aft chamber 134.

The closable gate is mounted inside the chamber and includes at each side of the aircraft three independently movable gates. Each movable gate is configured to fluidly isolate a corresponding chamber 130, 132 or 134. The closable gate also defines an engine chamber 136 in front of each engine. As shown in FIG. 9, the closable gate comprises a left forward gate 122 for isolating the left forward chamber 130, a left middle gate 124 for isolating the left middle chamber 132 and a left aft gate 126 for isolating the left aft chamber 134. These gates are opened, allowing airflow to pass through the gates when deactivated, and are closed for obstructing the airflow when activated.

The chamber segmentation wall 120 will be beneficial in the following scenarios:

1—Cater for single engine failure by closing the closable gates 122, 124, 126 adjacent to the failed engine to isolate the chamber 28 from the engine chamber 136 and prevent air from being sucked into the chamber 28 through the failed engine.

2—Act as a speed braking mechanism by selectively closing gates 122 and thereby creating form drag inside the forward chamber 130.

3 —In addition to the struts, the segmentation wall 120 can be used for mounting the outer skin 20 onto the aircraft.

4 —Improve handling of the aircraft by utilising air pressure around it. For examples:
A. In a cross wind condition: in a right sided cross wind condition, the forward gate 122 on the left side can be closed to obstruct the airflow and reduce suction on the left side, and thereby increasing pressure on the left side of the nose and pushing the nose to the right side to make up for the right side cross wing.
B. While taxiing the aircraft: the speed of the aircraft is low and the nose does not produce considerable drag, therefore closing gates 122 on both sides will increase suction from the middle and the aft parts, thus making the control surfaces more effective.
C. At high speed cruise condition: gates 126 and 124 may be actuated to reduce suction from the middle and aft parts thereby increasing suction at the nose, allowing for more drag reduction at such high speeds.

The above examples are merely for illustrative purposes. The use of the segmentation wall and the control of the gates can enable optimisation for other possible scenarios.

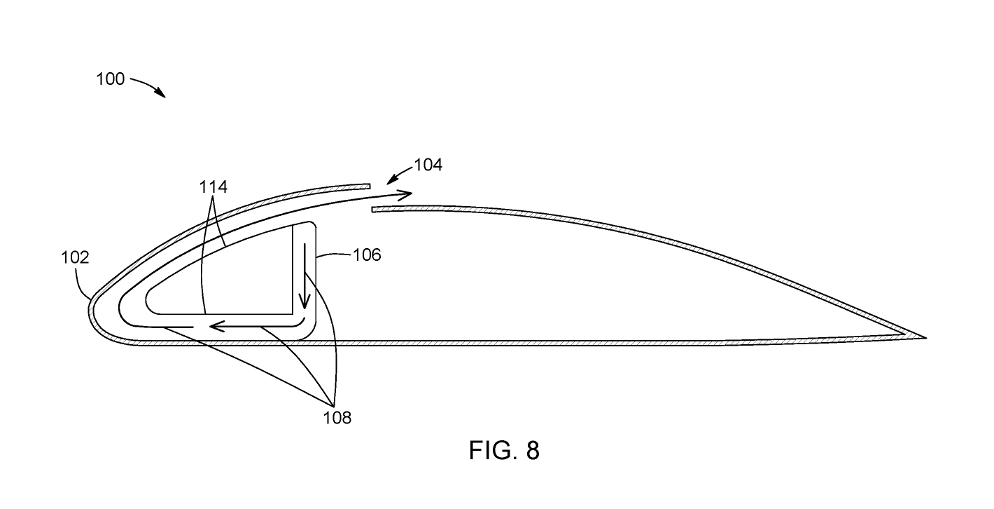

With reference to FIGS. 2 and 8, there is shown an aircraft wing 100 according to an embodiment of the present invention. The aircraft wing 100 has a design that can be used for minimizing an airfoil boundary layer separation and for de-icing a leading edge 102 of the wing 100.

The wing 100 comprises a slot 104 along a wingspan of said wing 100. The slot 104 refers to a narrow opening located on the upper surface of the wing 100 and approximately along the maximum thickness of the wing 100. The maximum thickness of the wing 100 may refer to the maximum thickness of each cross-section forming the wing 100.

In one embodiment, as shown in FIG. 8, the slot 104 is formed in a vertical plane with respect to the wing 100, such that edges of the slot 104 are positioned in a staggered configuration with respect to each other in the vertical plane.

The wing 100 also comprises an air duct 106 mounted inside the leading edge 102 of the wing 100 and is in fluid communication with air exhaust of an engine. The air duct 106 is configured to deflect a portion of the air exhaust from the engine towards the leading edge 102 and to cause the portion of the air exhaust exit through the slot 104. The amount of air exhaust to be deflected depends on several factors, such as aircraft speed, air exhaust temperature, ambient temperature, ice formation on the wing 100, etc. Rotatable deflectors with variable positions movable into exhaust stream can be used to control the amount of air exhaust to be deflected. The duct can refer to any duct, pipe, hose, channel conduit, or the like suitable for conveying the portion of the air exhaust therethrough.

With reference to FIG. 8, there is shown the portion of the air exhaust exiting the air duct 106 and being deflected by air deflectors 114 positioned in the leading edge 102. Deflected air exhaust 108 is directed towards the leading edge 102 which can warm and therefore de-ice the leading edge 102.

Exhaust air exiting the slot 104 can have higher velocity and temperature than the velocity and temperature of the ambient air. Since pressure decreases with higher velocity and temperature, the exhaust air can have lower pressure with reference to the ambient air and therefore, the ambient air will exert a force on the boundary layer of the wing, proportional to the pressure difference between the ambient air and air exhaust, for minimizing the airfoil boundary layer separation.

In some embodiments, the air duct 106 is in fluid communication with a corresponding air duct of a second wing and/or the fluid communication between the air duct 106 and the air exhaust of the engine is closable.

These embodiments can cater for an engine failure and/or single engine operation of the aircraft. In these scenarios, an inlet of the air duct 106 communicating with the inoperative engine exhaust can be closed. The operative engine can continue feeding air exhaust to both air duct, located in each wing.

In the above description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present invention illustrated in other figures can be easily inferred therefrom. The embodiments, geometrical configurations, materials mentioned and/or dimensions shown in the figures are optional, and are given for exemplification purposes only.

1. An air intake structure exposable to an airflow, for use on an aircraft having a fuselage, wings and engines, at least one of said engines having an air intake area and being mounted on top of the wings proximate the fuselage, for reducing drag and assisting aerodynamic control surfaces in controlling the aircraft, the air intake structure comprising:
an outer skin comprising a plurality of perforations, having an exterior surface exposable to the airflow and an opposite interior surface, mountable on the aircraft relative to the fuselage for creating a chamber between the outer skin and the fuselage, said outer skin defining a forward portion, a middle portion extending longitudinally along a roll axis to cover said at least one engine and adapted to restrict airflow into said at least one engine, and an aft portion;
a plurality of closing plates operatively mounted on the interior surface of the outer skin for covering corresponding perforations on the outer skin and movable between a closed position covering the corresponding perforations and, an open position, uncovering the corresponding perforations; and
an actuator operatively connected to the plurality of closing plates for positioning said plurality of closing plates between the closed position and the open position.

2. The air intake structure according to claim 1, wherein the plurality of perforations includes:
a plurality of forward perforations formed on the forward portion;
a plurality of middle perforations formed on the middle portion; and
a plurality of aft perforations formed on the aft portion.

3. The air intake structure according to claim 1 or 2, wherein the forward portion covers a nose cone of the aircraft.

4. The air intake structure according to any one of claims 1 to 3, wherein the aft portion covers a vertical stabilizer defining a port surface and an opposite starboard surface and a horizontal stabilizer defining a top surface and an opposite bottom surface.

5. The air intake structure according to any one of claims 1 to 4, wherein the middle portion covers a section of the fuselage extending between the forward portion and the aft portion.

6. The air intake structure according to any one of claims 1 to 5, wherein an offset distance between the outer skin and the fuselage is configured to allow sufficient air intake into the engines.

7. The air intake structure according to any one of claims 2 to 6, wherein the plurality of forward perforations gradually decreases in size along the roll axis from a tip of the nose cone to an end of the nose cone.

8. The air intake structure according to any one of claims 1 to 7, wherein the plurality of forward perforations defines an area that is configured to account for 50 to 75 percent of the air intake area of the engines.

9. The air intake structure according to any one of claims 1 to 8, wherein edges of the plurality of forward perforations and the plurality of aft perforations are operatively connected to a heating element for heating said plurality of forward perforations and plurality of aft perforations.

10. The air intake structure according to any one of claims 2 to 9, wherein the plurality of aft perforations includes vertical stabilizer perforations formed on the port surface and the starboard surface of the vertical stabilizer and horizontal stabilizer perforations formed on the top surface and bottom surface of the horizontal stabilizer.

11. The air intake structure according to any one of claims 2 to 10, wherein the plurality of aft perforations defines an area that is configured to account for 20 to 40 percent of the air intake area of the engines.

12. The air intake structure according to any one of claims 1 to 11, wherein a leading edge of the vertical stabilizer and a leading edge of the horizontal stabilizer include micro perforations.

13. The air intake structure according to any one of claims 1 to 12, wherein at least one edge of a windshield section of the aircraft is in fluid communication with the fuselage chamber.

14. The air intake structure according to any one of claims 1 to 13, wherein covering the plurality of closing plates on a surface of the vertical stabilizer causes a corresponding uncovering of the plurality of closing plates on the opposite surface of the vertical stabilizer.

15. The air intake structure according to any one of claims 1 to 14, wherein covering the plurality of closing plates on a surface of the horizontal stabilizer causes a corresponding uncovering of the plurality of closing plates on the opposite surface of the horizontal stabilizer.

16. The air intake structure according to any one of claims 1 to 15, wherein the air intake structure further includes struts connected to the interior surface of the outer skin and to the fuselage for mounting said outer skin onto the aircraft.

17. The air intake structure according to any one of claims 1 to 16, further comprising a chamber segmentation wall mounted inside the chamber and dividing said chamber into a left forward chamber, a left middle chamber, a left aft chamber, a right forward chamber, a right middle chamber and a right aft chamber.

18. The air intake structure according to any one of claims 1 to 17, further comprising a closable gate mounted inside the chamber for fluidly isolating airflow from a divided chamber selected from the group of the left forward chamber, the left middle chamber, the left aft chamber, the right forward chamber, the right middle chamber and the right aft chamber.

19. An aircraft wing for minimizing an airfoil boundary layer separation and de-icing a leading edge of the wing, the wing comprising:
a slot along a wingspan of the wing; and
an air duct mounted inside the leading edge of the wing and being in fluid communication with air exhaust of an engine, said air duct being configured to deflect a portion of the air exhaust from the engine towards the leading edge and to cause the portion of the air exhaust to exit through the slot.

20. An aircraft wing according to claim 19, wherein the air duct is in fluid communication with a corresponding air duct of a second wing.

21. An aircraft wing according to claim 19 or 20, further comprising an isolating system for fluidly isolating the air duct from the air exhaust of the engine.
